(19) United States
(12) Patent Application Publication
(10) Pub. No.: US 2026/0257736 A1
(43) Pub. Date: Sep. 3, 2026

(54) STRUCTURALLY INTEGRATED DUAL-LOAD-PATH ROLL-OFF AND TOWING TRUCK BODY ASSEMBLY

(71) Applicant: Kevin Lauze, Topsham, ME (US)

(72) Inventors: Kevin Lauze, Topsham, ME (US); Benjamin Riepe, Altoona, WI (US)

(21) Appl. No.: 19/555,062

(22) Filed: Mar. 3, 2026

Related U.S. Application Data
(60) Provisional application No. 63/766,167, filed on Mar. 3, 2025.

(51) Int. Cl. B60P 1/64

(52) U.S. Cl. CPC B62D 33/0207; B60P 7/04; B62D 21/02

(57) ABSTRACT

A structurally integrated truck body assembly is configured to selectively function as a roll-off bed system, a gooseneck towing system, and a rear-hitch towing system within a single chassis-mounted structure. The assembly includes a subframe secured to a truck chassis, a hoist assembly configured to load and unload a removable bed in a roll-off manner, and a gooseneck hitch assembly mounted to a secondary bracket system positioned beneath the subframe and substantially over a rear axle of the chassis.

### BACKGROUND INFORMATION

### Field of the Invention

The present invention relates generally to truck body assemblies for medium-and heavy-duty trucks, and more particularly to a structurally integrated truck body assembly having a dual-load-path architecture configured to selectively function in multiple manners within a single chassis-mounted structure.

### Discussion of Prior Art

In the field of truck body assemblies and accessories, vehicles are frequently adapted for multiple purposes, including hauling bulk cargo, transporting specialized equipment, and towing heavy trailers. In many commercial applications, particularly for class 3 through class 7 trucks, operators must frequently reconfigure a single truck to perform different tasks. Conventional truck configurations, however, are generally dedicated to a single purpose, requiring separate vehicles or extensive modification when transitioning between cargo hauling and trailer towing functions.

Hoist systems are commonly used to assist in loading and unloading heavy truck beds, cargo bodies, or equipment modules. Such systems typically employ a lifting mechanism mounted to the truck frame that allows a bed or body to be raised, lowered, or removed. While these hoist systems provide functional lifting capability, they are ordinarily integrated into a fixed truck body configuration. As a result, removal and replacement of entire truck beds can be labor-intensive, time-consuming, and dependent upon precise alignment between the hoist mechanism, mounting plates, and the truck frame.

A recurring challenge in conventional hoist-equipped truck bodies is the alignment and positioning of a hitch assembly, such as a gooseneck or plate hitch, relative to the truck's rear axle and frame mounting points. Proper positioning of the hitch is critical for safe towing performance, weight distribution, and compliance with vehicle load specifications. Existing systems often require significant manual adjustment, specialized tools, or permanent mounting structures that limit the operator's ability to selectively install or remove the hitch assembly when not needed.

Traditional truck bodies that incorporate a gooseneck hitch are generally dedicated to towing applications and may interfere with the use of the truck bed for other cargo-carrying purposes. Conversely, trucks configured primarily with a cargo body frequently lack a readily accessible or properly positioned hitch mounting structure. This lack of modularity forces operators to choose between a towing configuration and a cargo-hauling configuration, rather than enabling both functions within a single adaptable system.

In addition to hoist and hitch assemblies, many transportation applications require the use of cargo covers, such as tarp systems, to protect transported materials from weather and debris. Gantry-style tarp systems are commonly mounted to truck beds and include a supporting framework and retractable tarp. While such systems provide necessary protection, they are typically semi-permanent installations that are complex to attach or remove. This reduces flexibility when the truck bed must be interchanged or when the vehicle is reconfigured for towing rather than hauling.

Conventional gantry tarp systems often include multiple structural arms, support frames, rollers, winches, and fastening mechanisms that must be secured directly to the truck body. Installation and removal commonly require substantial manual effort and careful alignment of structural components. The tarp deployment and stowing processes may involve cranks, cables, or motorized rollers, and frequently require manual securing of tarp edges along the sides of the truck body. These processes can be time-consuming and may require multiple operators.

Moreover, traditional tarp systems are typically designed for a specific truck bed size and configuration. As a result, when a truck owner desires to switch between different cargo bodies—such as dump bodies, flatbeds, or specialty containers—the tarp system may not be compatible. Similarly, conventional hoist assemblies are often configured for a specific bed geometry and mounting footprint, limiting interchangeability between different body sizes or styles.

The lack of interchangeability among truck beds, hoist systems, hitch assemblies, and tarp systems results in operational inefficiencies. Fleet operators and individual owners may be required to maintain multiple trucks dedicated to distinct functions, or to perform lengthy mechanical conversions to reconfigure a single vehicle. This increases capital costs, storage requirements, and downtime, while reducing overall vehicle utilization.

Accordingly, there exists a need for a modular truck bed assembly that enables selective installation and removal of a cargo body relative to a truck frame using a hoist and roller system that facilitates controlled loading and unloading of the bed. There further exists a need for a removable or selectively installable gooseneck hitch assembly that can be positioned for proper weight distribution when towing yet removed when a clear cargo floor is desired.

Additionally, there is a need for a tarp assembly that is readily attachable to and removable from the cargo body, without extensive tools or permanent structural modifications, and that is adaptable to different body sizes or configurations. Such a system would allow a single truck chassis to be used interchangeably with multiple cargo bodies and operational configurations.

### BRIEF SUMMARY OF THE INVENTION

The present invention relates to a structurally integrated truck body assembly configured to selectively function as a roll-off bed system, a gooseneck towing system, and a rear-hitch towing system within a single chassis-mounted structure while maintaining rated load capacities.

The assembly includes a subframe secured to a truck chassis and engineered as a multi-functional load-distribution framework defining multiple selective load paths. A hoist assembly is mounted to the subframe and configured to load and unload a removable bed in roll-off fashion. The hoist is mounted in a reversed orientation to permit structural integration of a gooseneck hitch assembly positioned substantially over the rear axle. The gooseneck hitch is supported by a secondary bracket system mounted beneath the subframe, defining a towing load path distinct from the roll-off lifting load path. A rear hitch interface provides an additional towing load path through a rear portion of the subframe and chassis.

The system further includes adjustable and removable rear roller assemblies that facilitate loading and unloading of the removable bed while permitting selective repositioning or removal to provide unobstructed access to the rear hitch. The roller assemblies assist roll-off operations without altering the primary lifting or towing load paths.

In addition, a modular tarp mounting system is integrated into the structural subframe. Receiver members, including front-mounted square tube receivers that function as structural cross braces, are configured to removably receive tarp support members. The tarp system may therefore be selectively installed or removed without modification of primary structural members or interference with defined load paths.

Collectively, the system provides a structural dual-load-path integration architecture in which lifting forces and towing forces are selectively transferred through different structural portions of the same chassis-mounted assembly. The truck body remains installed while the vehicle performs roll-off loading, gooseneck towing, rear-hitch towing, and covered cargo hauling operations.

### BRIEF DESCRIPTION OF THE DRAWINGS

The present invention is described with reference to the accompanying drawings. In the drawings, reference numbers indicate identical or functionally similar elements. The drawings are not drawn to scale.

FIG. 1 is a perspective view of the truck body assembly according to the invention.

FIG. 2 is a perspective view of the truck body assembly with the hoist in a raised/open position.

FIG. 3 is a close-up perspective view of the truck body assembly showing the hoist assembly and tarp assembly.

FIG. 4 is a close view of a mounting point for the tarp assembly and a partial view of the hoist assembly.

FIG. 5 is a partial perspective view of the truck body assembly showing the hoist assembly, gooseneck mounting assembly, and hydraulic tank.

FIG. 6 is a close-up view of the tank bracket.

FIG. 7 is a close-up view of the gooseneck hitch assembly and rear roller assembly.

FIG. 8 is a close-up view of the roller assembly in an operational position.

FIG. 9 is a close-up view of the roller assembly in a stowed position.

FIG. 10 illustrates the truck body with a tarp deployed.

FIG. 11 is an illustration of the hoist mount in a conventional, prior art, system.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

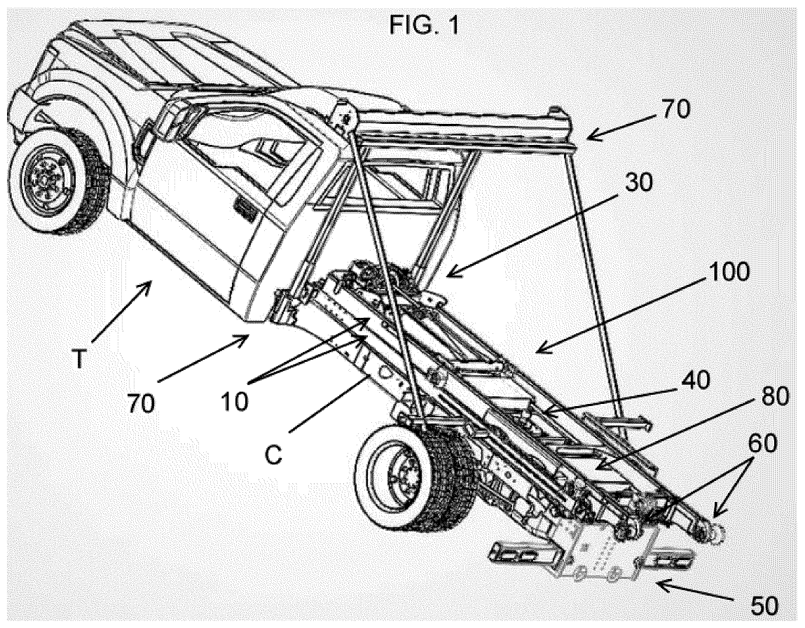

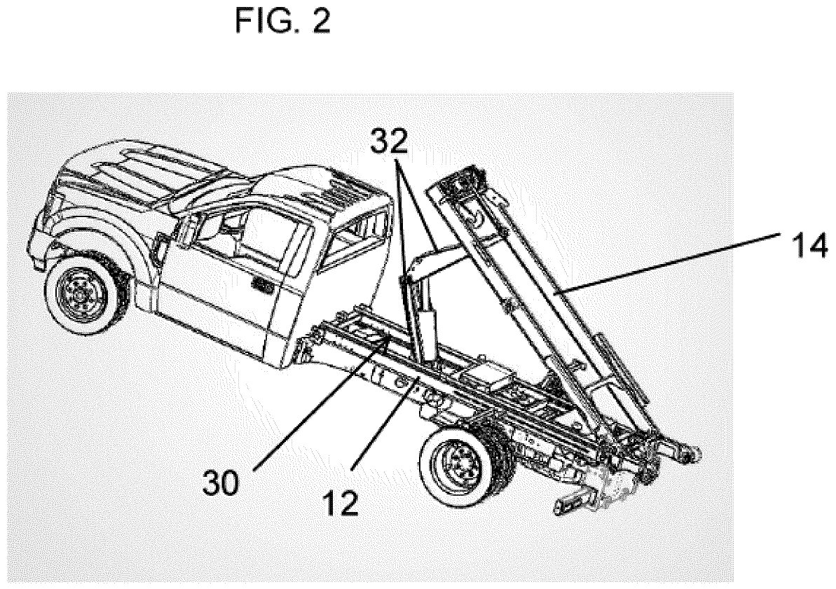

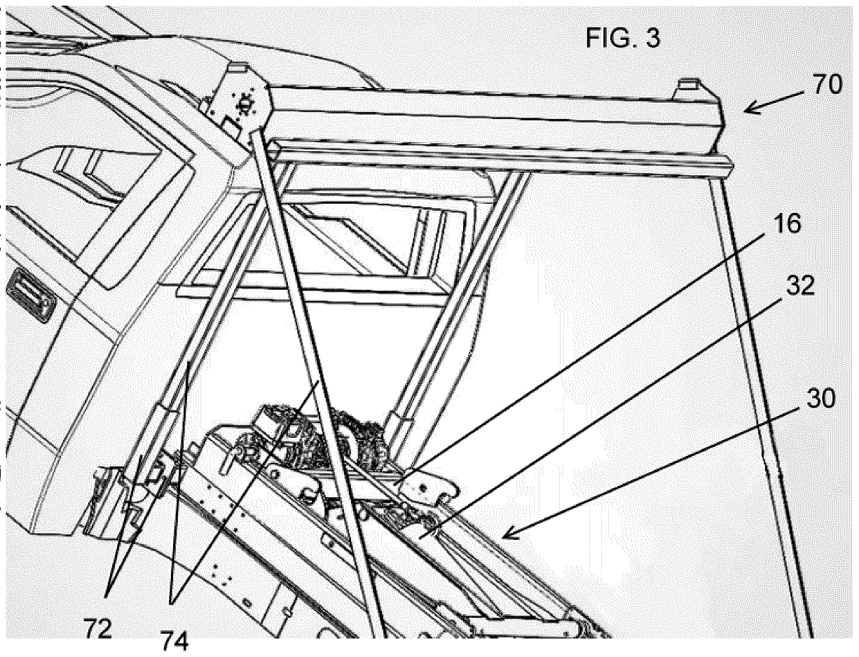

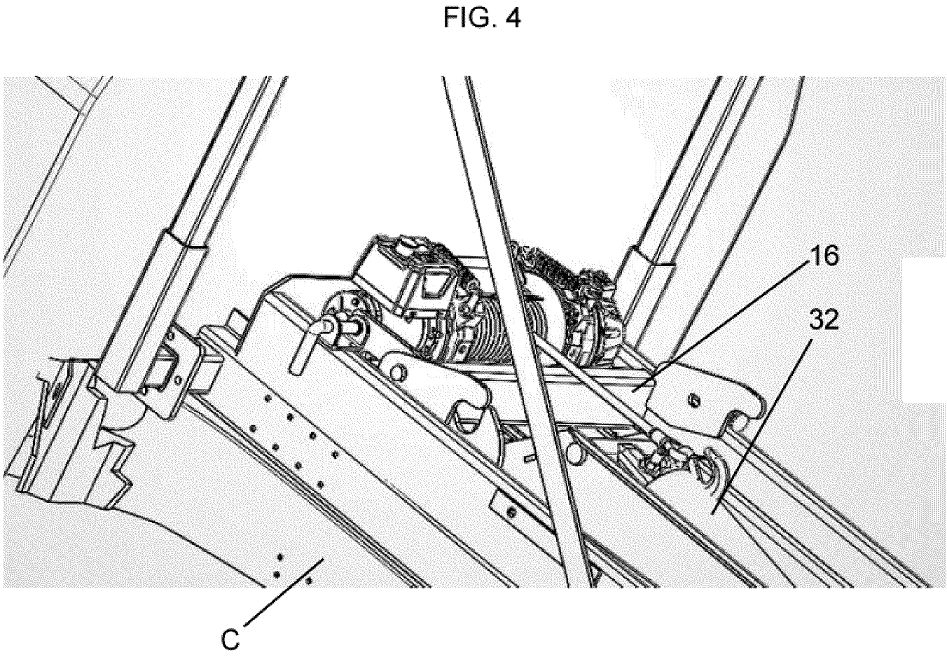

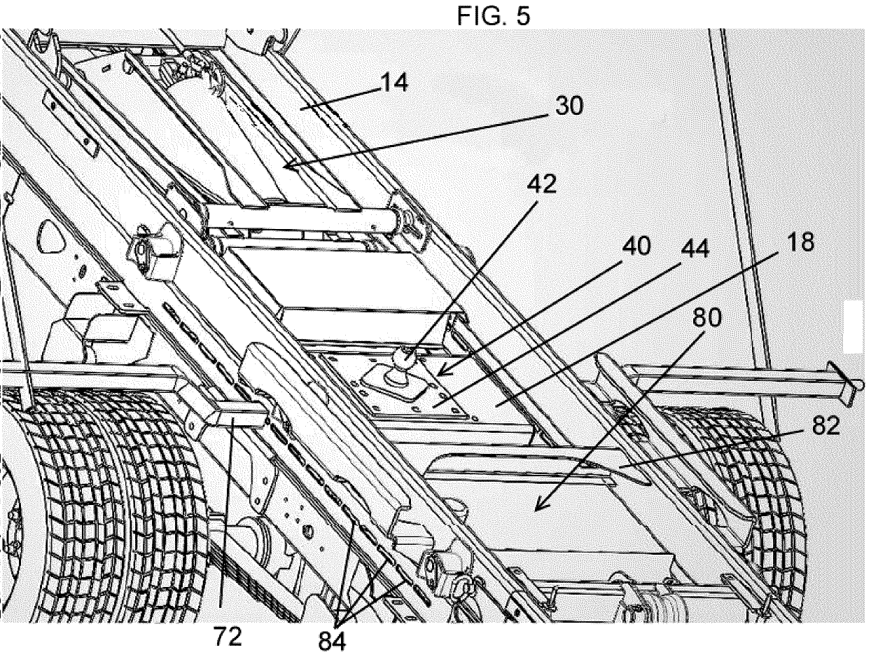

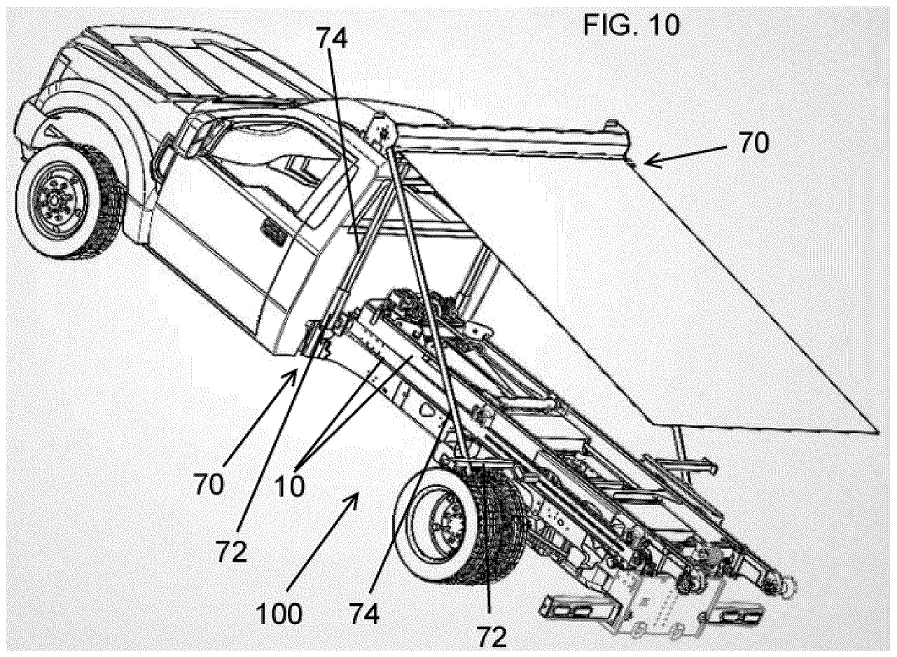

FIGS. 1-10 illustrate a chassis-mounted truck T body assembly 100 according to the invention, comprising a frame 10, hoist assembly 30, gooseneck hitch assembly 40, rear hitch interface 50, rear roller assembly 60, modular tarp mounting system 70, and custom hydraulic tank 80.

The frame 10 includes a subframe 12 is secured to the truck chassis rails and serves as a structural interface through which operational forces are selectively transmitted, and a top frame 14 that is capable of being raised and lowered relative to the subframe 12. The assembly is engineered as a structural dual-load-path architecture in which lifting forces and towing forces are distributed through distinct structural paths depending on the selected operational mode.

The truck body 100 remains installed during all modes of operation, and major structural members do not require removal or reconfiguration when transitioning between functions.

The hoist assembly 30 is mounted to the subframe 12 and includes movable support members 32 configured to raise and lower a removable truck bed (not shown) in a roll-off manner. The hoist 30 may be hydraulically actuated.

During roll-off operations, lifting forces are transmitted from the removable bed to the hoist support members 32, then from the hoist 30 to the subframe 10, and lastly from the subframe 12 into the chassis rails C. This defines a primary lifting load path. The subframe 12 includes cross-members 16 and reinforced structural portions configured to distribute these forces longitudinally and laterally along the chassis C while maintaining rated lifting capacity. In the original configuration, the hoist is mounted in a “forward-sloping” orientation, having: a base anchor, e.g. the fixed end of the cylinder is anchored to the lower subframe at a point closer to the front of the vehicle; an extension point, e.g. the rod end extends upward and rearward to connect to the tilting bed; and where the mechanical profile has a lift geometry requires the cylinder to push “away” from the pivot point to achieve elevation. The reverse mounted design utilizes a reverse-mounted geometry that fundamentally changes the force distribution. There is an inverted pivot, wherein the hoist is now anchored closer to the rear pivot assembly of the subframe. There is a forward-acting extension, such that the cylinder is oriented to extend toward the front of the vehicle, pushing “underneath” the tilting bed. And there is a slide assembly integration, such that by mounting the hoist in reverse, the actuator operates within a more compact footprint during the initial lift phase. This orientation allows the hoist to exert force on the bed at a steeper, more efficient angle from the onset of the lift.

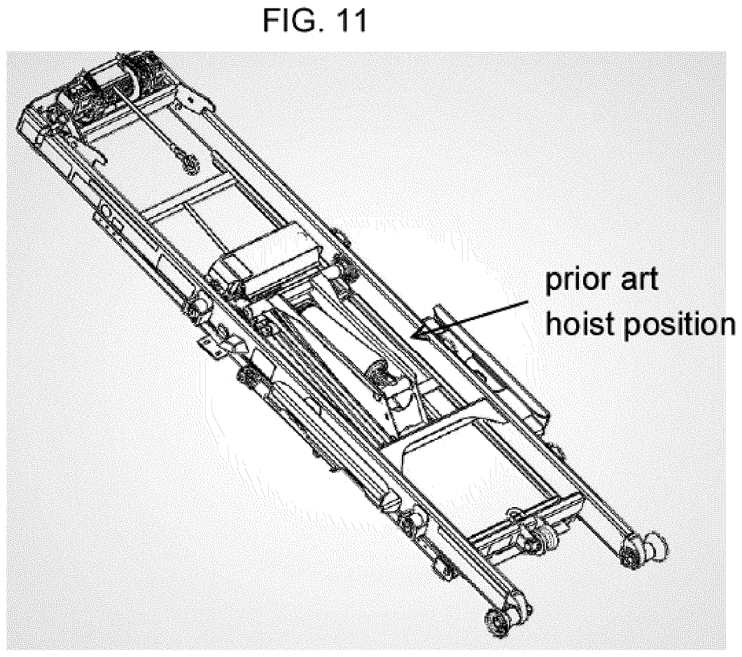

More specifically, the hoist 30 is mounted in a reversed orientation relative to conventional roll-off systems, with an example of a conventionally mounted system shown in FIG. 11. This reversed configuration preserves proper lifting geometry while enabling structural integration of the gooseneck hitch assembly 40 and a custom hydraulic tank 80. The primary distinction between the two configurations lies in the inverted mounting orientation of the hydraulic actuator (hoist) relative to the subframe and the tilting bed.

A gooseneck hitch assembly 40, comprising a gooseneck hitch 42 and a gooseneck bracket 44, is mounted to a secondary bracket system 18 coupled to the subframe 12 and chassis. More specifically, the bracket system 18 interfaces directly with structural portions of the chassis rails C and is positioned substantially over or slightly forward of the rear axle to optimize load transfer. This positioning is possible due to the position and orientation of the hoist 30.

During gooseneck towing operations, forces are transmitted: 1) from the trailer into the gooseneck hitch 42; 2) from the hitch 42 into the secondary bracket structure 18; and 3) from the bracket structure 18 directly into the chassis rails C.

This towing load path is structurally distinct from the roll-off lifting load path. The hoist 30 and subframe 12 remain installed but are not required to carry primary gooseneck towing forces, thereby preserving structural ratings and reducing cross-loading between functional systems.

The reverse-mounted hoist assembly 30 also provides space for the custom hydraulic tank 80 to be integrated into the subframe 10 with brackets 82 that attach to sub-frame slots 84. Compared to conventional tanks, the hydraulic tank 80 has a low-profile configuration, for example, it may have height of between 4-6 inches, a width of 25-30 inches, and a length of 15-17 inches. As a further example, a tank measuring 5.5″×16″×28″ is able to be mounted directly to the subframe and hold 12 gallons of fluid. The position of the tank 80 and hoist assembly 30 enable the gooseneck assembly to be positioned very near the rear axle, thus allowing for exceptional load hauling ability. The custom subframe 12 includes a series of slots 84, that allow for ease of installation of the tank 80 to clear the gooseneck bracket and to allow for ease of installation of mud flaps other outside accessories to be mounted to different chassis' without having to drill holes during installation.

The assembly 100 further supports a conventional rear hitch interface 90 located at a rear portion of the subframe 12 or chassis C. During rear-hitch towing operations, forces are transmitted: from the trailer into the rear hitch receiver, and from the receiver into the rear structural portion of the subframe and chassis. This defines a third load path within the integrated structure. The architecture allows selective use of either the gooseneck hitch or the rear hitch without modification to primary structural members.

A rear roller assembly 60 is mounted near a rear portion of the subframe 70 and is configured to facilitate roll-off loading and unloading of the removable bed.

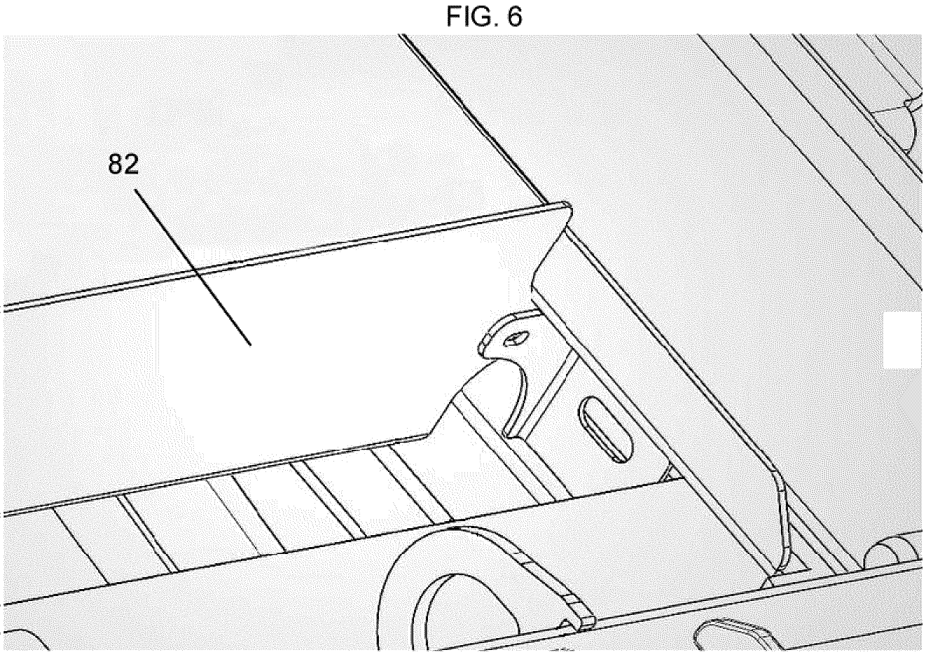

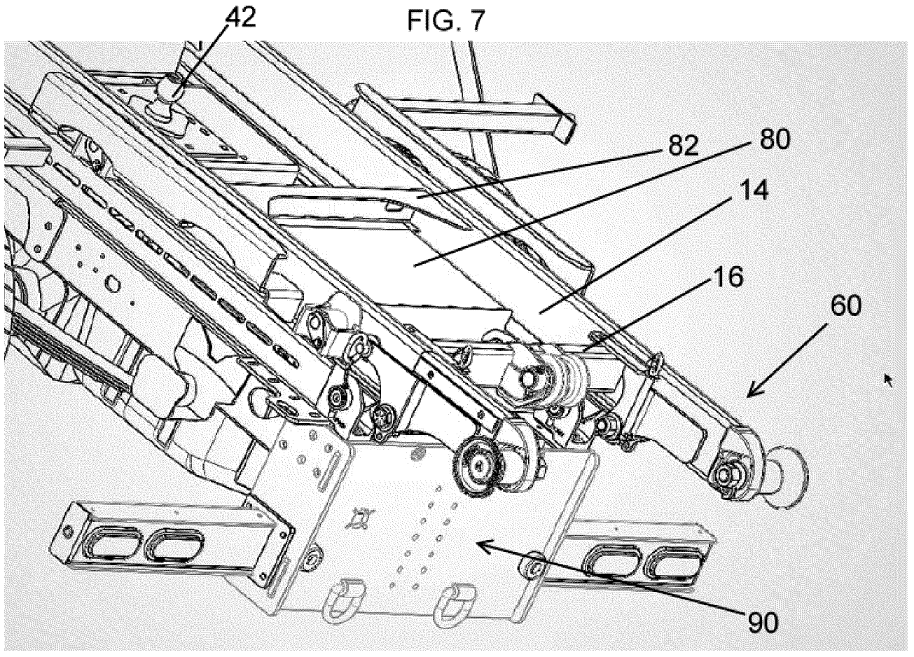

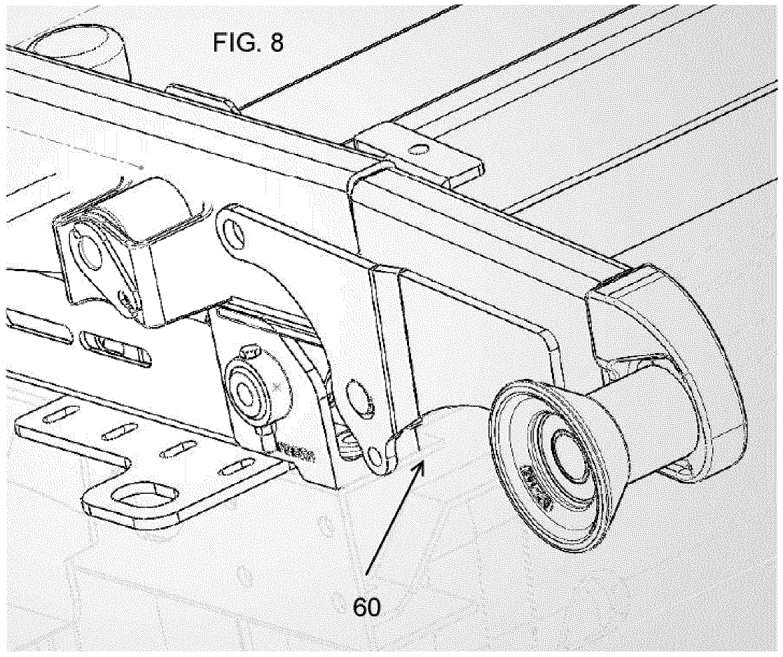

Roller assemblies 60 reduce friction and guides the bed during movement relative to the subframe. In preferred embodiments, the rollers are mounted to adjustable brackets that allow repositioning between an operative position, illustrated in FIGS. 6 and 7, aligned for roll-off loading, and a stowed or rotated position that clears the rear hitch receiver as illustrated in FIG. 8.

The rollers may also be fully removable. Importantly, the rear roller assemblies are not primary load-bearing members in either the lifting load path or towing load paths. Repositioning or removal of the rollers does not alter the structural integrity of the lifting or towing systems. This arrangement permits unobstructed rear-hitch towing while maintaining roll-off capability. The adjustability and removability of the rollers enable the user to easily mount a trailer to the rear hitch if they prefer the rear hitch over the gooseneck hitch.

The truck body assembly further includes the modular tarp mounting system 70, which is integrated into the subframe 12. Receiving members 72 are secured to the subframe 12 and configured to removably accept tarp securing members 74. In preferred embodiments, three-inch square tube receivers are integrated into opposing front side portions of the subframe. These receivers serve dual purposes: structurally, they function as cross braces that reinforce the forward portion of the subframe and contribute to torsional rigidity under lifting and towing loads. Functionally, they provide removable mounting points for a tarp top kit or gantry-style tarp support system.

Securing members 74 include insertable portions configured to slide into the receivers and be retained using locking pins or fasteners. Forward and rear securing members may support tarp arms in fixed or pivoting relationships to permit deployment and retraction of the tarp. In the embodiment shown in the drawings, there are three-inch square tube receivers integrated into the front sides of the system so that it can easily be added on as an option. The receiver tube also acts as a front cross brace for support.

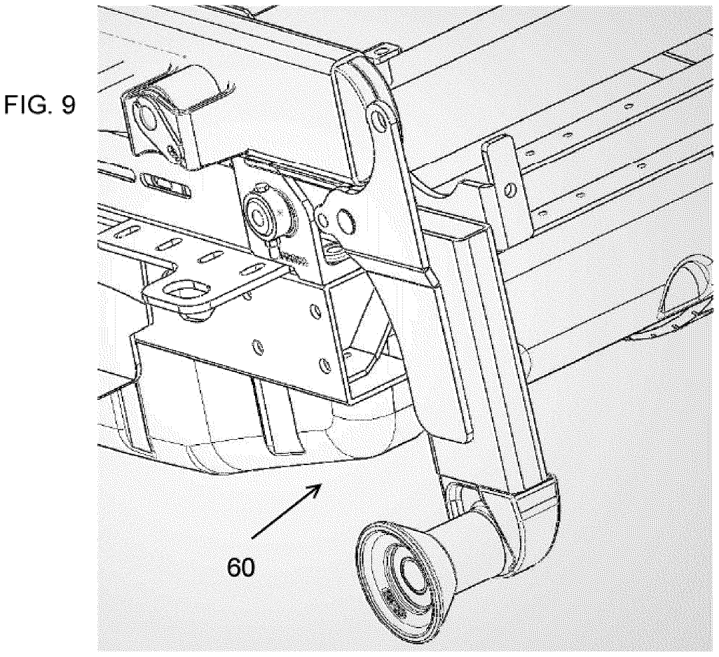

Because the tarp mounting system is integrated into structural receiver members that already serve load-distribution functions, installation or removal of the tarp assembly does not alter the defined lifting or towing load paths. Note that FIG. 9 illustrates a tarp open over the top position of where it would go for a multitude of different products that may be secured to the assembly 100, exactly where it would extend and how it would be secure varies based on the are different configurations of dump bodies.

The disclosed assembly 100 enables the truck to selectively operate as: a roll-off bed system; a gooseneck towing system; a rear-hitch towing system; and a covered cargo hauling system utilizing the modular tarp assembly. These functions are enabled within a unified chassis-mounted structure that defines selective load paths for lifting and towing forces. The truck body remains installed, and no major structural members require removal or reconfiguration when transitioning between modes.

The assembly 100 therefore provides a structural load-distribution architecture that allows selective transfer of lifting and towing forces through different portions of the same integrated assembly while maintaining load ratings.

The various components disclosed in the assembly are assembled using conventional techniques. As used herein, coupling mechanisms, threaded fastening elements, and other fastening, joining, and attachment mechanisms, include but are not limited to: threaded fasteners such as machine screws, self-tapping screws, thread-forming screws, shoulder bolts, set screws (grub screws), studs, captive fasteners, threaded inserts (including metallic, polymeric, molded-in, or press-fit inserts), thread-repair inserts (including helicoil-type inserts), knurled inserts, and expansion-type threaded fasteners; rivets and permanent mechanical fasteners, including solid rivets, blind rivets (pop rivets), structural rivets, drive rivets, and clinch-type fasteners such as self-clinching nuts, studs, and pins; pins and pin-based retention devices, including roll pins (spring pins), dowel pins, taper pins, ball-lock pins, detent pins, snap-fit pins, and retaining pins; quick-release and quarter-turn fasteners, including quarter-turn fasteners, bayonet-style connectors, cam-lock fasteners, over-center latches, toggle clamps, and similar mechanisms; press-fit and interference-based attachment mechanisms, including press-fit joints, interference fits, shrink fits, and expansion fasteners; Adhesive-based bonding systems, including structural adhesives, epoxies, anaerobic adhesives, acrylic adhesives, polyurethane adhesives, pressure-sensitive adhesives, and tape-based bonding systems; welding and metallurgical joining techniques, including spot welding, MIG welding, TIG welding, laser welding, ultrasonic welding, friction welding, brazing, and soldering; hybrid or combined fastening systems, including combinations of mechanical fasteners and adhesives, pins and clamps, threaded fasteners with locating features, and snap-fit features with secondary locking mechanisms; and ancillary retention and securing elements, including spring clips, retaining rings (internal and external), circlips, wire forms, and elastic bands or straps for industrial or structural applications

It is understood that the embodiments described herein are merely illustrative of the present invention. Variations in the system may be contemplated by one skilled in the art without limiting the intended scope of the invention herein disclosed.

What is claimed is:

1: A chassis-mounted truck body assembly comprising:
a subframe configured to be secured to chassis rails of a truck chassis;
a hoist assembly mounted to the subframe and configured to raise and lower a removable bed relative to the subframe to load and unload the removable bed in a roll-off manner, wherein, during said raising and lowering, lifting forces are transferred through a lifting load path from the removable bed to the hoist assembly, from the hoist assembly to the subframe, and from the subframe to the chassis rails;
and a gooseneck hitch assembly mounted to a secondary bracket system coupled to the subframe, wherein, during gooseneck towing, towing forces are transferred through a towing load path from the gooseneck hitch assembly to the secondary bracket system and from the secondary bracket system to the chassis rails, and wherein the towing load path is structurally distinct from the lifting load path
wherein the hoist assembly is mounted to the subframe in a reversed orientation relative to a conventional roll-off hoist orientation.

2: The chassis-mounted truck body assembly of claim 1, wherein the hoist assembly is hydraulically actuated.

3: The chassis-mounted truck body assembly of claim 1, wherein the secondary bracket system is configured to interface directly with structural portions of the chassis rails.

4: The chassis-mounted truck body assembly of claim 1, wherein the gooseneck hitch assembly is positioned substantially over a rear axle of the truck chassis.

5: The chassis-mounted truck body assembly of claim 4, wherein the gooseneck hitch assembly is positioned slightly forward of the rear axle.

6: The chassis-mounted truck body assembly of claim 1, further comprising a rear hitch interface positioned at a rear portion of the subframe or the truck chassis, wherein, during rear-hitch towing, rear-hitch towing forces are transferred from a trailer to the rear hitch interface and from the rear hitch interface to the rear portion of the subframe or the truck chassis.

7: The chassis-mounted truck body assembly of claim 6, further comprising a rear roller assembly mounted near a rear portion of the subframe and configured to facilitate movement of the removable bed relative to the subframe during roll-off loading and unloading.

8: The chassis-mounted truck body assembly of claim 7, wherein the rear roller assembly is mounted to adjustable brackets and is adjustable between (i) an operative position aligned for roll-off loading and (ii) a stowed position that clears the rear hitch interface.

9: A chassis-mounted truck body assembly comprising:
a subframe configured to be secured to chassis rails of a truck chassis;
receiver members secured to the subframe at a forward portion of the subframe, wherein the receiver members are structural members that function as cross braces of the subframe;
and tarp support members comprising insertable portions configured to be removably received by the receiver members to support a tarp assembly relative to the subframe.

10: The chassis-mounted truck body assembly of claim 9, wherein the receiver members comprise square tube receivers.

11: The chassis-mounted truck body assembly of claim 10, wherein the square tube receivers comprise three-inch square tube receivers.

12: The chassis-mounted truck body assembly of claim 9, wherein the receiver members are integrated into opposing front side portions of the subframe.

13: The chassis-mounted truck body assembly of claim 9, further comprising locking pins or fasteners configured to retain the insertable portions of the tarp support members in the receiver members.

14: The chassis-mounted truck body assembly of claim 9, wherein the receiver members contribute to torsional rigidity of the forward portion of the subframe under lifting and towing loads.

15: The chassis-mounted truck body assembly of claim 9, further comprising a rear roller assembly mounted near a rear portion of the subframe and configured to facilitate roll-off loading and unloading of the removable bed.

16: The chassis-mounted truck body assembly of claim 15, wherein the rear roller assembly is configured to be repositioned to provide unobstructed access to a rear hitch interface.
The chassis-mounted truck body assembly of claim 15, wherein the rear roller assembly is removable from the subframe
